(19) United States
(12) Patent Application Publication
(10) Pub. No.: US 2002/0115044 A1
(43) Pub. Date: Aug. 22, 2002

(54) System and method for computer-assisted language instruction

(76) Inventor: Zeev Shpiro, Ra'anana (IL)

Correspondence Address: David A. Hall, Heller Ehrman White & McAuliffe LLP, 7th Floor, 4350 La Jolla Village Drive, San Diego, CA, 92122-1246, US

(21) Appl. No.: 10/044,266

(22) Filed: Jan. 10, 2002

Related U.S. Application Data
(60) Provisional application No. 60/260,944, filed on Jan. 10, 2001.

(51) Int. Cl. G09B 19/00

(52) U.S. Cl. 434/156

(57) ABSTRACT

A system provides language instruction through oral production of phrases by a user by receiving a spoken input from the user and recognizing the spoken input as being one of multiple permitted input phrases having a predetermined meaning, and analyzes the spoken input so as to identify a departure of the spoken input from a desired oral production of the permitted input phrase. A system response to the spoken input may be implemented in accordance with the predetermined meaning of the permitted input phrase. The system response may be implemented according to the phrases that the system knows the user was trying to say, even while the system recognizes the departure of what the user said from the input phrase the user was attempting to say.

### REFERENCE TO RELATED PRIORITY APPLICATION

This application claims the benefit of priority from co-pending U.S. Provisional Patent Application Ser. No. 60/260,944 filed Jan. 10, 2001 entitled “System and Method for Computer-Assisted Language Instruction” by Z. Shpiro. Priority of the filing date of Jan. 10, 2001 is hereby claimed, and the disclosure of the Provisional Patent Application is hereby incorporated by reference.

### BACKGROUND OF THE INVENTION

1. Field of the Invention

This invention relates generally to computer assisted instruction and, more particularly, to computer assisted language instruction through analysis of spoken input.

2. Description of the Related Art

Students learn to speak a foreign language most effectively with repeated practice in speaking words of the foreign language. Typically, a collection of exercises is provided to guide the student through learning and provide an opportunity for repeated practice. For younger students, it is especially important to provide an interesting variety of exercises to provide motivation for continued study. Computer-assisted instruction can be a good source of variety in study exercises, can provide an accurate assessment of a student's progress, and can be available at all times of day or night, at the convenience of the user.

One difficulty in receiving language instruction through computer-assisted systems is in receiving effective feedback. Most computer-assisted systems receive spoken input from a system user, use speech recognition processing engines to determine whether the user's input corresponds to a target phrase, and then make a “satisfactory” or “not satisfactory” assessment of the user's spoken input. Errors in pronunciation are frequently met with repeated presentations of desired pronunciation. The user therefore may be unsure of what aspect in the user's pronunciation is lacking. Thus, the student will likely be unaware of the severity of the user's departure from the desired pronunciation.

The repeated exposure to the same pronunciation drills and exercises can be very frustrating for the system user. Without an interesting variety of exercises and effective feedback on the user's attempts at pronunciation, the user can quickly lose motivation and desire to continue with language instruction.

From the discussion above, it should be apparent that there is a need for a system that teaches oral production of phrases by a user in a target language such that a desired phrase the user is attempting to say is determined, and a determination is made of the difference between the desired phrase the user was attempting to say, and the actual phrase spoken by the user. The present invention fulfills this need.

### SUMMARY OF THE INVENTION

In accordance with the present invention, a system for providing language instruction through oral production of phrases by a user receives a spoken input from the user and recognizes the spoken input as being one of alternative permitted input phrases having a predetermined meaning, and analyzes the spoken input so as to identify a departure of the spoken input from a desired oral production of the permitted input phrase. A system response to the spoken input may be implemented in accordance with the predetermined meaning of the permitted input phrase. Thus, a system response may be implemented according to the word that the system recognizes the user was trying to say, even while the system recognizes the departure of what the user said from the input phrase the user was attempting to say. In this way, the system teaches oral production of phrases by a user in a target language such that a desired phrase the user is attempting to say is determined, and a determination is made of the difference between the desired phrase the user was attempting to say, and the actual phrase spoken by the user.

The user spoken input may include a combination of multiple permitted inputs, and each of the inputs is recognized and analyzed. In one aspect of the invention, the system response comprises producing a visualization of the permitted input phrase on a display device. In another aspect of the invention, the user is presented with a learning presentation that teaches the user a desired input phrase prior to the system receiving the spoken input from the user. The system may permit the user to practice producing the permitted input phrase by repeatedly receiving, recognizing, and analyzing the spoken input from the user. In another aspect of the invention, the identified departure of the spoken input from the desired oral production is specified in terms of a percentage away from the desired oral production by the spoken input. Alternatively, the identified departure of the spoken input is specified in terms of a specific error in the spoken input as compared to the desired oral production.

Other features and advantages of the present invention should be apparent from the following description of the preferred embodiment, which illustrates, by way of example, the principles of the invention.

### BRIEF DESCRIPTION OF THE DRAWINGS

FIG. 1 is a representation of a language instruction system constructed in accordance with the present invention.

FIG. 2 is a representation of a screen display of the computer illustrated in FIG. 1 showing a page of the book illustrated in FIG. 1.

FIG. 3 is a representation of a screen display of the computer illustrated in FIG. 1 showing a “word help” window relating to a page of the book illustrated in FIG. 1.

FIG. 4 is a representation of a screen display of the computer illustrated in FIG. 1 showing a “word practice” window relating to a page of the book illustrated in FIG. 1.

FIG. 5 is a table of contents display for a Words application provided over the computer illustrated in FIG. 1.

FIG. 6 is a representation of a word practice screen display of the FIG. 1 computer.

FIG. 7 is a representation of a story panel array page in the book illustrated in FIG. 1, for selection by the user.

FIG. 8 is a representation of a story panel selection screen display of the FIG. 1 computer.

FIG. 9 is a representation of a story panel response screen display of the FIG. 1 computer.

FIG. 10 is a display screen representation of the user response to the FIG. 9 story panel display screen.

FIG. 11 is a representation of the system response to the FIG. 10 screen, indicating an incorrect response.

FIG. 12 is a representation of a story panel completion screen display of the FIG. 1 computer.

FIG. 13 is a Puzzle display page of the FIG. 1 computer.

FIG. 14 is a non-contextual language instruction display page of the FIG. 1 computer.

FIG. 15 is a non-contextual language instruction display page that involves user interaction through the FIG. 1 computer.

FIG. 16 is a block diagram representation of a computer used in the system illustrated in FIG. 1.

FIG. 17 is a flow diagram that illustrates operations of the system illustrated in FIG. 1.

FIG. 18 is a flow diagram representation of a language preposition instruction display page shown on the display screen of the FIG. 1 computer.

FIG. 19 is a representation of a user viewing a preposition instruction display page of the FIG. 1 computer.

FIG. 20 is a representation of a system implemented response to the user spoken input from the FIG. 19 display.

### DETAILED DESCRIPTION

A language instruction system constructed in accordance with the present invention teaches language through eliciting oral production of phrases, or utterances, from a user. The user provides the verbal utterances in response to prompting, either by a computer display stimulus event or by a page from supplementary written materials, such as workbooks. The system provides effective feedback to guide the user in better pronunciation of words in a target language.

### System

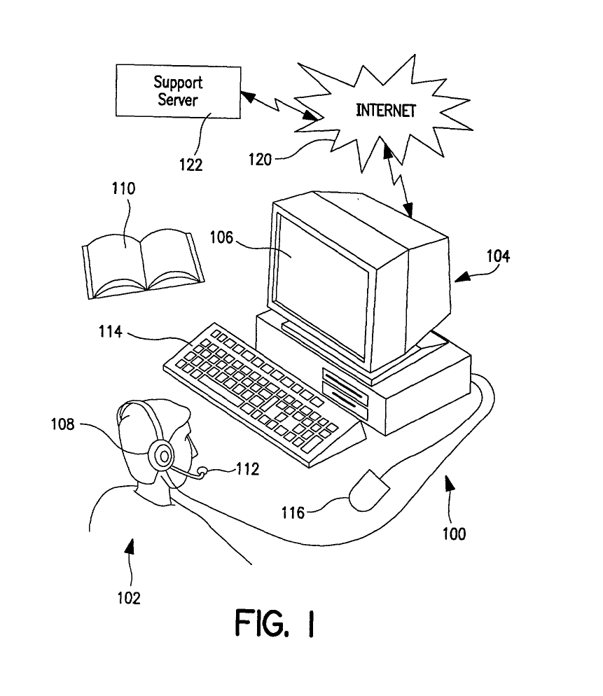

FIG. 1 is a representation of a system 100 that teaches oral production of words by a user 102 wherein a language processor 104 of the system receives a spoken input from the user and recognizes the spoken input as being one of multiple permitted input phrases having a predetermined meaning, and analyzes the spoken input so as to identify a departure of the user's spoken input from a desired oral production of the permitted input phrase. The language processor may comprise, for example, a Personal Computer or other processing device that can receive spoken input. A system response to the spoken input may be implemented in accordance with the predetermined meaning of the permitted input phrase. Thus, a system response may be implemented according to the words that the system knows the user was trying to say, even while the system recognizes the departure of what the user said from the input phrase the user was attempting to say.

The user 102 is presented with a stimulus event, preferably through a multimedia presentation of the language processor computer 104, that prompts the user for an input. The language processor 104 may produce a multimedia presentation comprising a combination of visual information on a display 106 of the computer and audio information delivered to the user 102 through a headset or speakers 108 connected to the computer. The user may also be presented with a stimulus event through a supplemental book 110, as described further below. The user 102 responds to the stimulus event by speaking into a microphone 112. The microphone transduces spoken phrases from the user and produces an audio signal that is provided to the computer 104. The user may also provide data input to the system through a computer keyboard 114 or display mouse 116.

When the user 102 speaks into the microphone 112, the user's spoken phrase or utterance is transduced into an audio signal and is received by the language processor computer 104. The microphone may be connected to the computer by hard-wired or wireless connection. The language processor computer preferably analyzes the audio signal corresponding to the user's spoken input and determines whether the user's spoken input is a properly spoken phrase in a target language. The language processor preferably communicates the determination to the user through a display message or other output. The language processor computer 104 preferably communicates over a network 120, such as the Internet, with a support server 122. The network communication 120 provides a means for receiving processing support and data from the support server, such as additional multimedia presentations for the user, record keeping for the user's progress, and for administrative functioning of the system 100. The support server 122 can have a configuration similar to that of the user computer 104, having a display, keyboard, and display mouse, and typically includes greater processing power and data storage capabilities.

The language processor computer 104 may be provided in a simpler configuration, such as a hand-held computer, a personal digital assistant (PDA), telephone, or any other device capable of receiving spoken input from the user, transducing the spoken input to produce an audio signal that can be communicated to the support server 122, and communicating information back to the user.

### BOOK READER

In accordance with the present invention, the computer assisted language instruction may involve supplemental written materials, such as a book. When the user launches the system, the book is read to the user by a native speaker in the target language, accompanying a multimedia presentation, as described below. The user may follow the multimedia presentation in the book reader, communicating with the support server for additional material and for feedback.

### Book Support Displays

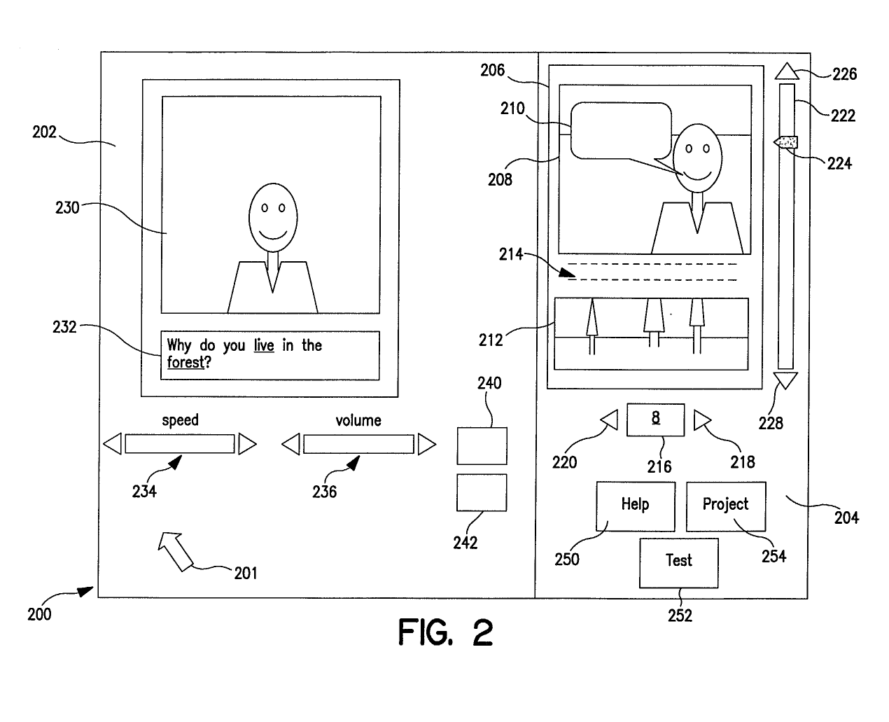

The computer-assisted instruction system can be used to supplement and support readings in a book. FIG. 2 shows a main screen display 200 of the language processor computer 104 illustrated in FIG. 1 that supplements material contained in the book 110 (FIG. 1). In the preferred embodiment, the computer 104 is a computer that supports a graphical user interface, so that computer assisted instruction is provided through a window operating system environment. Therefore, the computer display shown in FIG. 2 is shown as a window display that will be familiar to those skilled in the art. The display cursor 201 is a conventional artifact of the window display that likewise will be familiar to those skilled in the art as a means of display navigation.

The main screen window display 200 of FIG. 2 includes a book content presentation portion 202 and a book representation portion 204. The book representation portion 204 includes a reproduction 206 of a page from the accompanying book 110 (FIG. 1) and the book content presentation portion 202 provides a convenient interface for the user to the information content of the page.

For example, the reproduction frame 206 shows that the illustrated page from the book includes an illustration 208 that contains a drawing of a book character and a dialogue bubble 210 that contains text representing spoken dialogue from the book character. The reproduction frame 206 also shows that the page from the book includes a second illustration 212, which may or may not include dialogue, and also shows that the two illustrations 208, 212 are separated on the page by text 214. When the user initiates the system operation through the main screen, the system will begin playing a multimedia presentation in which the text of the book 110 is read to the user in the voice of a native speaker in the target language, as described further below.

The user interface of the reproduction frame 206 also includes navigational aids for moving about within the book and for moving on the page. The navigational aids include, for example, a page index box 216 that shows the page number corresponding to the page from the book being shown in the reproduction frame 206, with display buttons to move forward 218 and back 220 in the book content. A page scroll bar 222 includes an index mark 224 that indicates the approximate location on the page that corresponds to the location on the page from which the multimedia presentation is reading, and corresponds to the display being shown in the book content presentation portion 202. The user may move the index mark 224 along the page scroll bar 222 by using keyboard cursor controls or a display mouse to move to a desired portion for playback. Thus, the page being shown in the reproduction frame 206 will remain the same while the user moves the index mark 224, and the system will change the presentation being shown in the content presentation portion 202 as the user moves the index mark.

Turning to the content presentation portion 202 of the main screen display 200, the system typically provides a presentation that relates to the location of the page indicated by the index mark 224. In the FIG. 2 illustration, for example, the index mark 224 is approximately at the location of the first illustration 208, and therefore the content presentation portion 202 shows a reproduction 230 that corresponds to the illustration 208, albeit in a larger size and without the dialogue bubble to provide a more convenient and pleasing presentation. Text from the dialogue bubble 210 is instead placed below the reformatted illustration 230 in a text box 232. The text in the text box shows the text that is being read to the user in the multimedia presentation. Each word in the text box is highlighted on the main screen display as the word is read to the user.

In the preferred embodiment, the system provides a multimedia presentation of material to supplement the book content. The content presentation portion 202 of the computer display shows the graphical reproduction portion 230 of the multimedia display, which changes as the text portion is read to the user, so that the graphic images 230 are synchronized with the audio portion of the multimedia presentation. FIG. 2 also shows that the multimedia presentation may be controlled through display buttons for controlling speed 234 and volume level 236. Thus, if the user lowers the speed 234, the audio portion will be played more slowly and the graphic images 230 will also change more slowly, maintaining synchronization. Other display buttons may be provided to control stop 240 and play 242 functions for the multimedia presentation.

The user interface illustrated by the FIG. 2 main screen display 200 will preferably be provided by a simple interface program that can be installed and launched by the user on the computer 104. The interface program may be obtained from a program product, such as a CD-ROM disc, or the interface program may be received over a network data connection, such as the Internet, or through a combination of means. The data necessary for the multimedia display may be obtained in the same way, or in a combination of the two. For example, the user computer 104 may download a sufficient amount of data over the network data connection to provide several pages of presentation such as illustrated in FIG. 2. As the user navigates among the book information, it may become necessary for the computer to obtain additional or replacement data to provide a requested display. In that case, the interface program will preferably automatically send a request to a network location for the needed data. A variety of network access control schemes may be implemented, such as described in the pending U.S. provisional patent application entitled “Access Control for Interactive Leaming System” by Z. Shpiro and E. Cohen, filed Dec. 18, 2000.

Additional features of the user interface shown in the display page 200 include a Help display button 250, a Test display button 252, and a Project display button 254. The Help button 250 provides the user with access to a help file for explanation and assistance with the interface program. The Test display button 252 initiates a user language comprehension test feature of the system, to enable the user to undergo an examination of the user's language skills. The Project display button 254 initiates a user project feature of the system in which a user may participate in activities such as written assignments comprising completion of reports, letters, summaries, and the like, and other actions intended to practice user skills in language study.

### Word Help

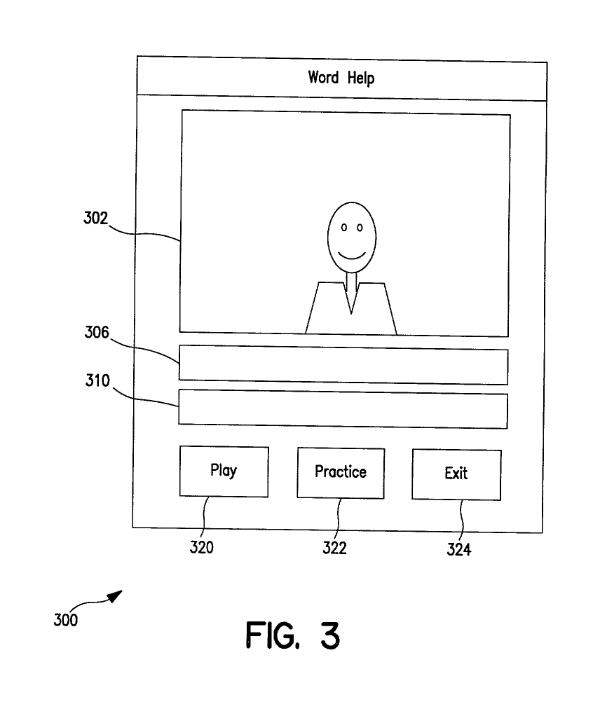

FIG. 3 is a representation of a screen display of the computer 104 illustrated in FIG. 1 showing a “Word Help” window 300. The Word Help window is opened when the user positions the display cursor and clicks on any word in the text box 232 of the content presentation window 202 (FIG. 2). The Word Help window may be a full size (full display screen) window or may be a reduced size window that floats over the main screen 200 of the user interface. The Word Help window 300 is a means for the user to initiate receiving additional information and pronunciation practice on a word in the text box 232.

The Word Help window 300 includes an illustration 302 that relates to the clicked-on word. For example, if the user clicked on a character name or illustration in the presentation window 202, such as “Robin Hood”, then the system would likely display a drawing or representation of that character. If the user clicked on an underlined word in the presentation window 202 corresponding to an object, such as “forest”, then the system would display an illustration that is representative of that object.

In addition to displaying a helpful illustration 302, the Word Help window 300 also provides a written text reproduction box 306 that contains the word itself, as written in the target language. The window also includes a native text box 310 that contains the word itself as translated into the user's native language. The system also supports the user in acquiring spoken language skills by providing a spoken presentation of the clicked-on word with opportunity for user practice. The system will automatically cue a spoken presentation of the word when the user selects a “Play” display button 320. The system will then provide the user with an opportunity to speak the word by taking the user to a practice window when the user selects the “Practice” display button 322. The Exit button 324 terminates the Word Help window and returns the user to the main screen 200.

### Word Practice

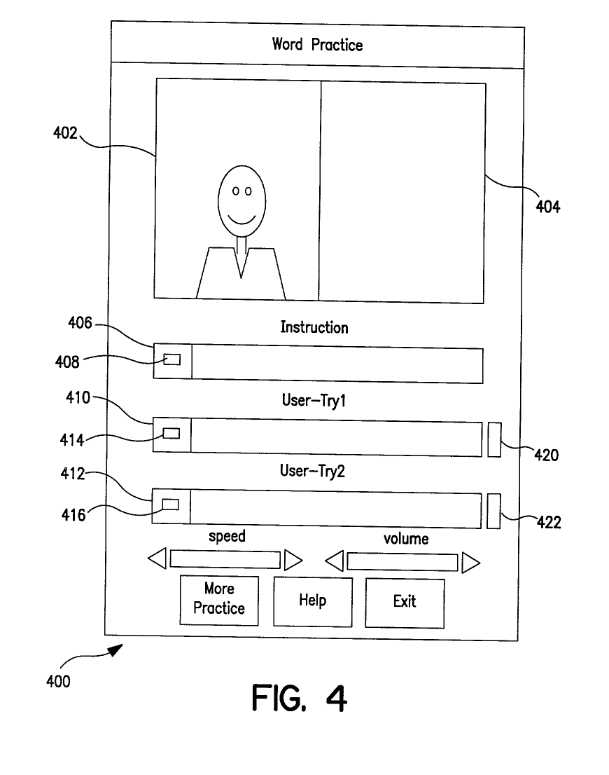

FIG. 4 is a representation of a screen display of the computer illustrated in FIG. 1 showing a “Word Practice” window 400. The Word Practice window is produced by the system when the user selects the “Practice” button 322 from the Word Help display (FIG. 3). The Word Practice feature gives a user additional practice relating to any selected word that is available from data in the user computer 104 or in the support server 122 (FIG. 1) that is accessible through the Practice button of FIG. 3. As with the Word Help feature, the Word Practice window may be a full size (full display screen) window or may be a reduced size window that floats over the main screen 200 of the user interface.

The Word Practice window 400 includes a word illustration box 402, as well as a text box 404 that contains the word itself in the target language and also in the native language of the user (similar to the respective boxes 306, 310 described in connection with FIG. 3). The Word Practice window 400 provides a spoken presentation of the word being practiced, and provides a graphical illustration of an audio signal corresponding to the spoken word in an instruction box 406. A “Play” display button 408 permits the user control over initiating playback of the instructional spoken presentation.

The system will permit the user to have two practice attempts at pronouncing the practice word, as indicated by the user input boxes 410, 412. Each respective input box 410, 412 includes a Record button 414, 416 to initiate recording of the user spoken input. When the user clicks on a “Record” button 414, 416, the system will receive the user's spoken input through the microphone 112 (FIG. 1) and will perform analysis on the input, generating an audio signal display in the respective practice boxes 410, 412. In this way, the instructional spoken presentation provides a desired oral production for the practice word. After the user speaks the practice word, an audio signal representation corresponding to the user's spoken input is displayed in each input box 410, 412. After the user has recorded a spoken input, the record button 414, 416 changes its function to initiate playback of the user's input, rather than to initiating recording.

Each representation 410, 412 of the user's two attempts at speaking includes a rating bar 420, 422 that indicates the departure of the user's spoken input from the desired oral production. The rating bars serve as a quality indicator of the user's speech as compared to the instructional presentation. The rating bar may be used to specify the departure of the user's speech from the desired oral production in terms of a likelihood that the user's spoken input corresponds to the desired oral production, or may be specified in terms of one or more specific errors in the spoken input as compared to the desired oral production.

### LANGUAGE EXERCISES

In accordance with the present invention, the computer assisted language instruction may involve supplemental written materials that comprise a book of language exercises. The user would follow along in the exercise book, communicating with the support server for additional material and for feedback.

### Exercise Book Contents

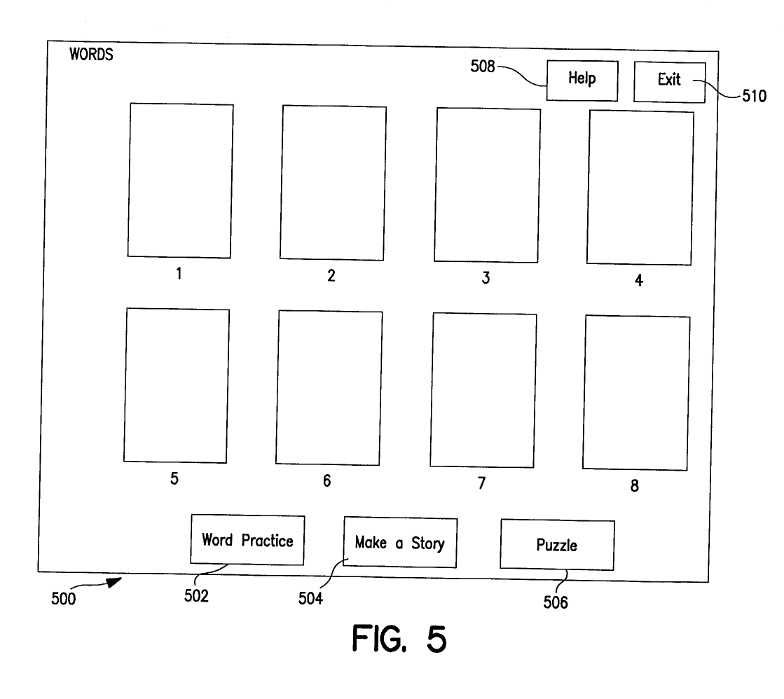

FIG. 5 is a table of contents display for an exercise book application called “Words” provided over the computer illustrated in FIG. 1. That is, the computer-assisted language instruction that may be provided in accordance with the present invention may involve supporting an exercise book, so that the exercise book may comprise the book 110 shown in FIG. 1. In such a situation, FIG. 5 shows a sequence of different themes or chapters in an exercise book. A user may select a particular theme or chapter, and then may select the type of exercises to be performed by selecting an appropriate display button. In FIG. 5, the exercises may be selected from Word Practice 502, Make a Story 504, and Puzzle 506 display buttons. In FIG. 5, a total of eight different themes or chapters are indicated, but a different number may be provided as well. A Help display button 508 permits the user to select system help, and an Exit display button 510 may be selected by the user to quit the user interface application.

### Word Practice

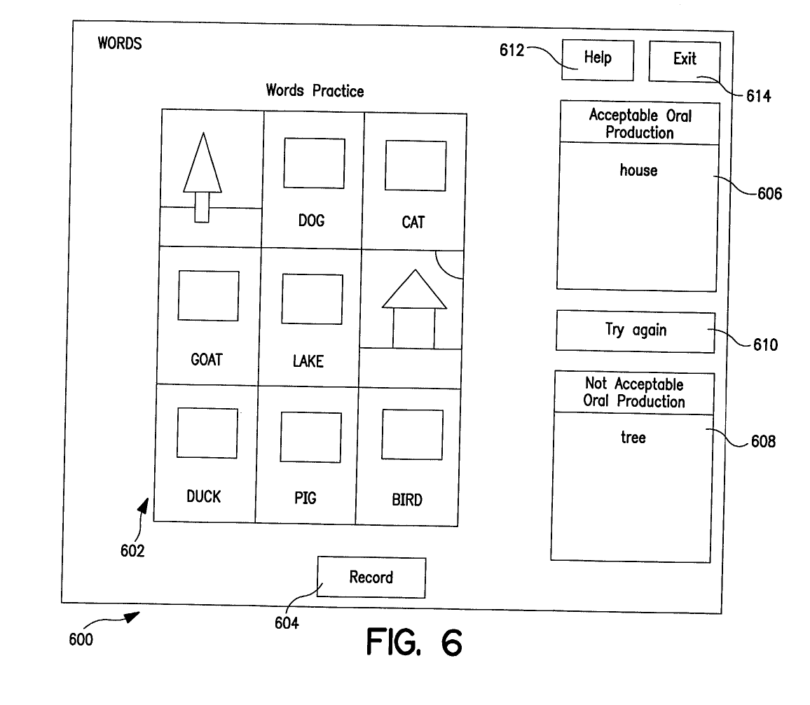

FIG. 6 is a representation of a Word Practice screen display 600 of the FIG. 1 computer. The Word Practice exercise display is produced in response to a user selecting the “Word Practice” display button 502 (FIG. 5) and permits a user to gain practice opportunities with a set of words that will be used throughout the exercise book 110. It should be noted, however, that the words shown in FIG. 6 are for illustrative purposes only, and it should be noted that the boxes 602 may contain other prompts or triggers for the user's spoken input. For example, the boxes 602 may contain sound or phrase links, numerals, letters, or colors, each of which the user may say out loud. In this description, references to “practice words” shall be understood to refer to any such prompt that may be placed in the boxes 602, and therefore may refer to sounds, phrases, numerals, letters, or colors.

More particularly, the Word Practice display shows an array of word boxes 602 in the target language with a graphic image or representation accompanying each word. The image helps the user in understanding the meaning of each word. The user selects a word for practice by clicking on the corresponding word box 602. A record display button 604 initiates a recording mode in which the user speaks into the microphone and the language processor computer receives a corresponding audio signal. The recording mode is initiated when the user clicks on a word box or, alternatively, when the user clicks on the record button 604, and is terminated upon the user clicks on the button a second time, or may also be terminated upon passing of a fixed time period with no oral input from the user.

After the user speaks into the microphone and the computer receives the user's spoken input, the computer analyzes the spoken input to determine if the spoken input is a permitted word, and the computer analyzes the spoken input to determine if the spoken input was acceptably close to a reference oral production or instructional presentation of the word in the corresponding word box 602 that was selected by the user. In the case of the Word Practice exercise, a permitted word is the word that the user selected for practice. The reference oral production may comprise, for example, a sequence of phonemes from a database or other audio signal representation suitable for comparison. If the analysis shows that the user's spoken input was acceptably close to the desired oral production of the word in the word box 602, then the word is placed in the “Acceptable Oral Production” box 606 of the display. In the preferred embodiment, the displayed word boxes are changed when the user achieves an acceptable oral production. For example, in FIG. 6, each word box initially includes a word that is spelled out in the target language, along with a thumbnail image that is illustrative of the word. When the user provides spoken input that is judged acceptably close to the desired oral production, the image within the word box is enlarged to occupy the full area of the box 602. Other visual transformations of the box may be used, and will occur to those skilled in the art.

If the user's spoken input is judged not acceptably close to the desired oral production of the selected word, then the word is placed in the “Not Acceptable Oral Production” box 608 of the display. The corresponding word box 602 may be changed for each word spoken, whether or not the pronunciation is judged acceptably close, but preferably the word box is changed in a manner different from that for words that are judged acceptably close to the desired oral production. That is, a spoken input may be judged acceptably close or not acceptably close with respect to a selected word, and the appearance of the corresponding box 602 will be changed accordingly. For example, a spoken word that is the permitted word (that is, the word that was spoken by the user is the correct word), but which the user did not pronounce acceptably close to the desired oral production, may be grayed out or may be illustrated in a black and white presentation, while a spoken word that is the permitted word and is acceptably pronounced may be illustrated with a color representation. A “Try Again” display button 610 permits the user to attempt an additional spoken input for a word that was not produced acceptably close. If desired, the system can enforce a limit on the number of times a user may attempt pronunciation, so that the Try Again button does not work if a predetermined number of assistance requests have already been requested. Alternatively, the system response to the Try Again button may be a function of the number of retry attempts, as described further below. Finally, a Help display button 612 permits the user to select system help, and an Exit display button 614 may be selected by the user to quit this “Word Practice” user interface application or return to the main screen (FIG. 5).

### Make a Story

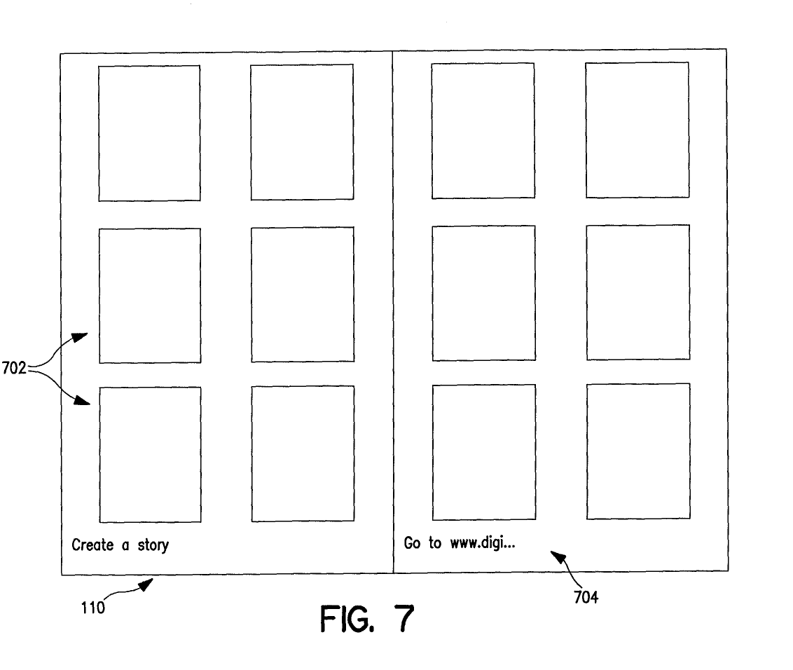

FIG. 7 is a representation of a story panel page array in the book 110 illustrated in FIG. 1, for selection by the user in accordance with the user interface program of the computer assisted system. That is, one of the exercises included in the book 110 comprises a page that is illustrated with story elements that a user may combine in real time in conjunction with pronunciation exercises performed with the user interface program. As illustrated in FIG. 7, the page in the book includes multiple story panels 702 and a direction to a network location 704, such as an Internet site. At the Internet site, as described further below, the user will be guided through a series of exercises such that one or more of the story panels 702 may be combined to fashion a story, which may then be reviewed by the user.

Fashioning a story in this manner provides the user with increased practice in speaking and comprehension, and the evolving story line provides motivation for the user to continue along in the exercise to completion. This process improves the user's language skills and increases the user's enjoyment while doing so. Story lines can be adapted for the particular user audience. For example, if the user audience is envisioned to be relatively young children, then an animal story may provide the desired interest and entertainment, while a story line for older audiences might be for a different topic.

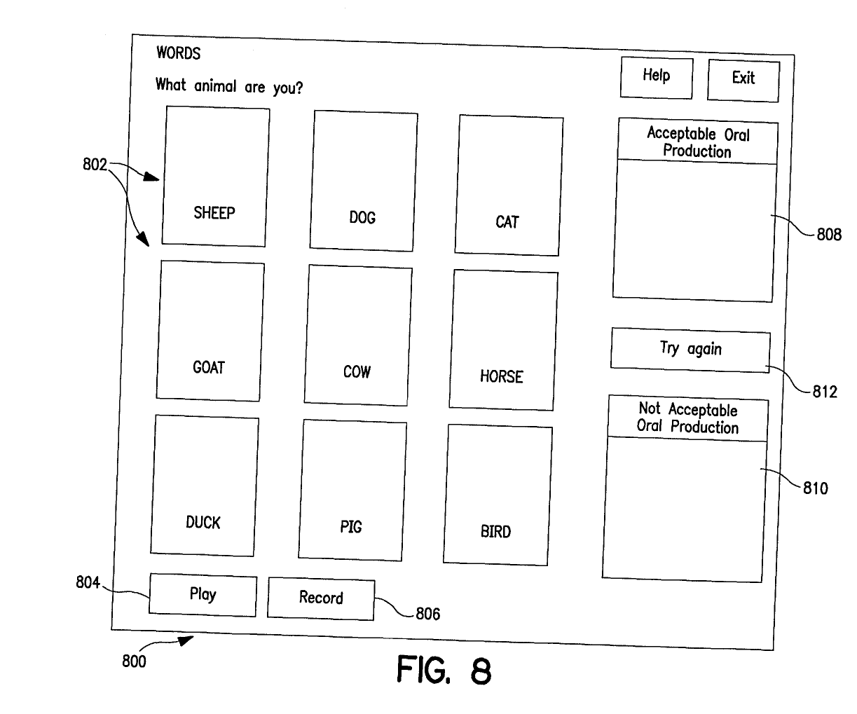

FIG. 8 is an example of a story panel selection screen display 800 that the user will observe upon using the FIG. 1 computer to go to the Internet site 704. FIG. 8 shows multiple display boxes 802, one of which the user will select to initiate the story-making exercise. For example, the user may be requested to select from display boxes that represent characters whose role will be assumed by the user upon selection. In the illustrated embodiment, the display boxes comprise animals, such as dog, cat, horse, pig, and bird. The user will be asked to select an animal, and the story to be created by the user will involve that animal. It should be noted that there is no one correct box for the user to select, rather, there are multiple permissible choices the user may make. Any one of the boxes 802, and the corresponding content, will be a permitted as a prompt for a spoken input.

When the user selects one of the display boxes 802, the user may select a Play display button 804 to hear a reference pronunciation of the corresponding word or phrase. The reference pronunciation is preferably by a native speaker of the target language, and comprises an example of the desired oral production of the phrase. The system will then prompt the user to speak the corresponding phrase and supply a spoken input, such as by directing the user to begin speaking the phrase or to click on a Record display button 806 to begin a recording mode. As with the previous display screen, if the user's spoken input of the phrase is one of the permitted phrases, and if the user's spoken input is analyzed and judged to be acceptably close to the desired oral production, then the word or phrase will be placed in the “Acceptable Oral Production” box 808, and if the spoken input is a permitted phrase but not acceptably close to the desired oral production, then the phrase is placed in the “Not Acceptable Oral Production” box 810. Also as before, a spoken input that is a permitted phrase and is acceptably close results in a change in the box 802, and a permitted phrase that is not acceptably close results in a different change in the box. The Try Again display button 812 permits additional attempts, in the manner as described above.

In the case of the FIG. 8 screen, a permitted phrase is a phrase that corresponds to one of the boxes 802. Any one of the boxes 802 is an appropriate response by the user to the prompt, which in FIG. 8 is shown as the question “What animal are you?” A spoken input that cannot be matched to one of the boxes 802 will be judged not to be a permitted phrase.

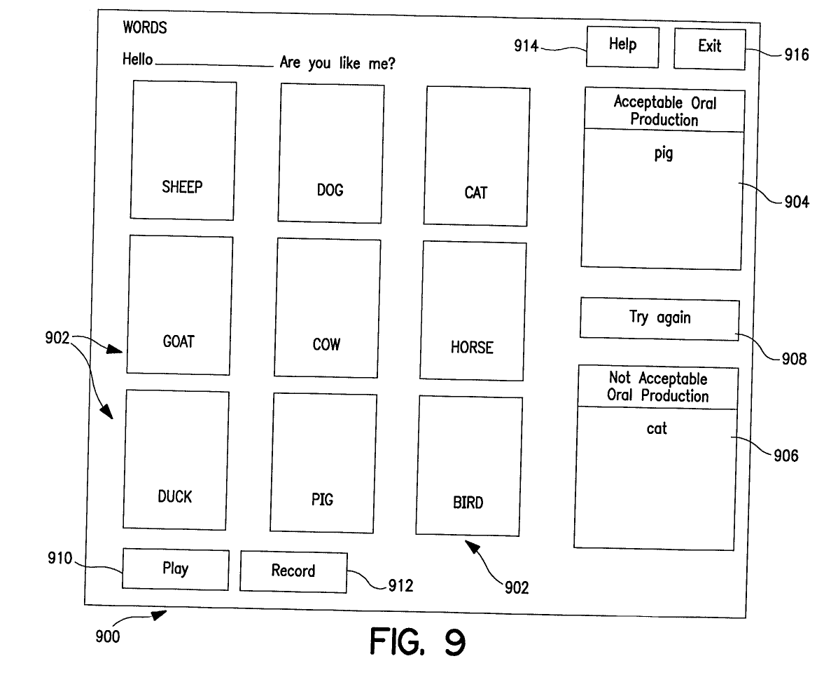

FIG. 9 is a representation of a story panel response screen display 900 of the FIG. 1 computer, following selection of a FIG. 8 story box and an accepted pronunciation of the corresponding phrase. FIG. 9 is similar to the display screen of FIG. 8, having multiple story panels 902, except that rather than a prompt to select an initial story panel such as in FIG. 8 (“What animal are you?”), the FIG. 9 display shows a prompt to continue the story line and select another panel. For example, in FIG. 9, the user prompt is to answer a question, “Hello [blank]. Are you like me?”. The user will then be expected to select a story panel that relates to the story panel initially selected from FIG. 8. Thus, if the user selected the phrase “pig” from FIG. 8 (as indicated by its presence in the “Acceptable Oral Production” box 904), then the user would be expected to select the corresponding box in FIG. 9 (“pig”) and to acceptably pronounce the phrase. As before, whether the user's spoken input is acceptable is considered relative to how close the user's spoken input is to a desired oral production. In general, the greater the departure of the user's spoken input from the desired oral production, the less likely the spoken input will be acceptable. As before, the FIG. 9 display also includes a Not Acceptable Oral Production box 906, a Try Again box 908, and also includes Play 910 and Record 912 display buttons, as well as Help 914 and Exit 916 buttons.

It should be noted that, unlike the choices presented to the user in FIG. 8, only one of the choices presented in the display screen of FIG. 9 is a permitted phrase, in that only one of the alternatives illustrated in FIG. 9 is the one that, when properly pronounced by the user, will match the desired oral production. For example, if the user selected “pig” from FIG. 8, then the user should select “pig” from FIG. 9. That is, in this instance, there is only one permitted response. The user's spoken input, if it is the proper response, will then be analyzed and will either be categorized as acceptably close to the desired oral production, or not acceptably close to the desired oral production.

If desired, the system may treat the range of spoken input that will comprise a permitted word as depending on the user's native language. In such a case, the error or departure of the user's spoken input from the desired oral production may be different for users who speak different native languages. For example, it is known that Arabic language native speakers typically have some difficulty pronouncing the “P” sound in English (due to the absence of “P” from the Arabic language). As a result, an Arabic native speaker who attempts to pronounce “pig” may only be able to generate a spoken input that sounds most similar to “big”. The system takes this difficulty into account, in that if the word or phrase to be pronounced is “pig” and the system analysis indicates that the user's spoken input was determined to be “big”, then the system will consider this response to comprise a permitted phrase if the user is an Arabic native speaker. That is, the system will recognize that the user was attempting to say “pig” but was only able to produce “big”. That response, for the Arabic native speaker, therefore comprises a spoken input that is a permitted phrase but is not acceptably close to the desired oral production.

In contrast, native speakers of French or German, for example, are not known to have difficulty in pronouncing both the “b” sound and “p” sound in English. Continuing the example from above, if the user selected “pig” from among the boxes 802, the desired oral production will be “pig”. For these native speakers, the system takes the lack of difficulty between “b” and “p” into account. Therefore, if the word or phrase to be pronounced is “pig” and the system analysis indicates that the French or German user's spoken input was determined to be “big”, then the system will consider this response to comprise a decision by the user to say “big”, and therefore the system will consider such a response to be a phrase that is not a permitted phrase. That is, the system will recognize that the user was not even attempting to say “pig”. The response of “big” rather than “pig”, for the French or German native speaker, therefore comprises a spoken input that is not a permitted phrase. The system therefore need not analyze the spoken input further to determine if it is acceptably close to the desired oral production. Rather, the system will indicate an erroneous response.

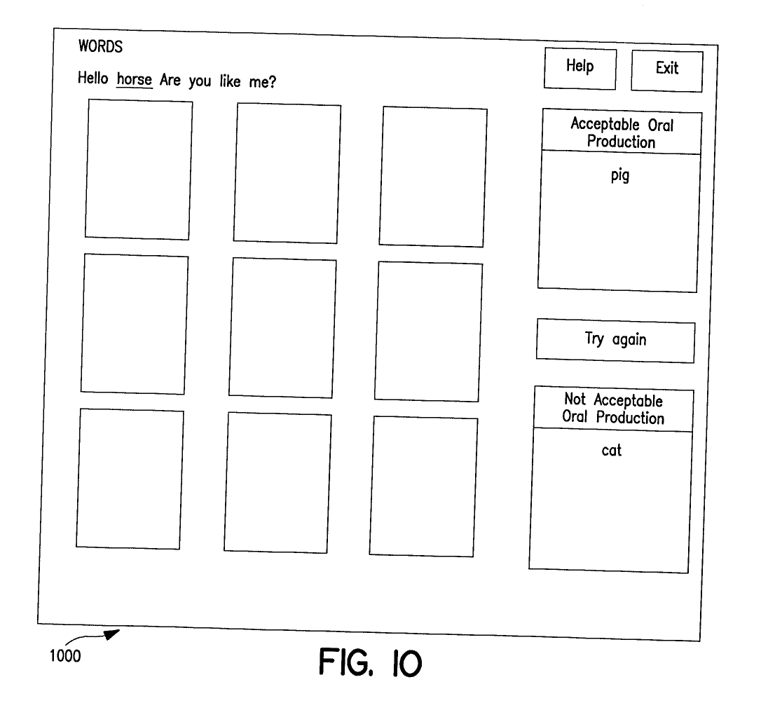

FIG. 10 is a display screen representation 1000 of the user response to the FIG. 9 screen, indicating that the user has responded with the word “Horse”. That is, the user has spoken the word “Horse” into the microphone in response to the prompt “Hello, [blank]”, the computer has analyzed the user's spoken input response, and the computer has determined that the spoken input is “Horse”.

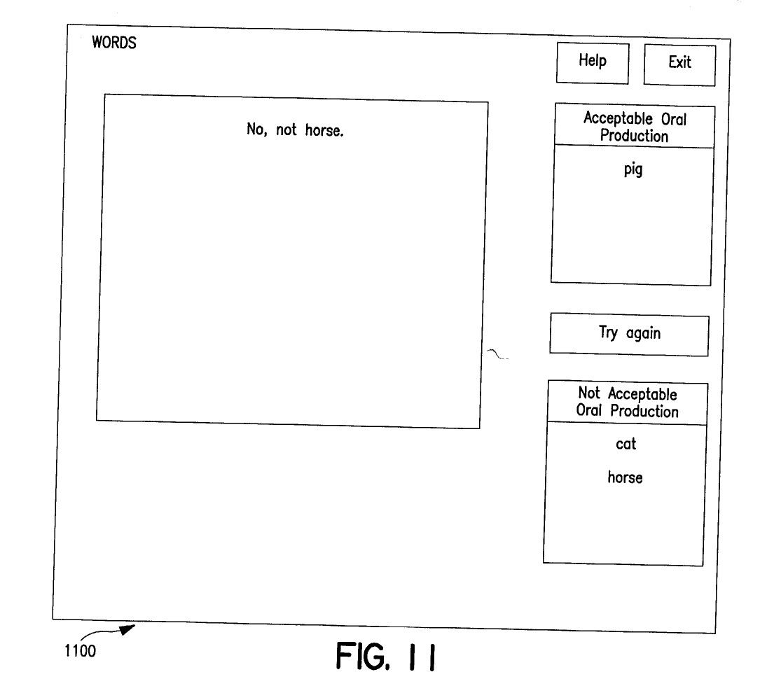

FIG. 11 is a display screen representation 1100 of the system response to the FIG. 10 input screen, indicating an incorrect response. FIG. 11 indicates that the user has responded with “Horse”, whereas the desired response was “Duck”. As a result, FIG. 11 shows a response box containing an error message to the user, to wit, “No, not horse.” The user may continue by selecting the Try Again display button to return to the FIG. 10 display, subject to the Try Again button limitations referred to above.

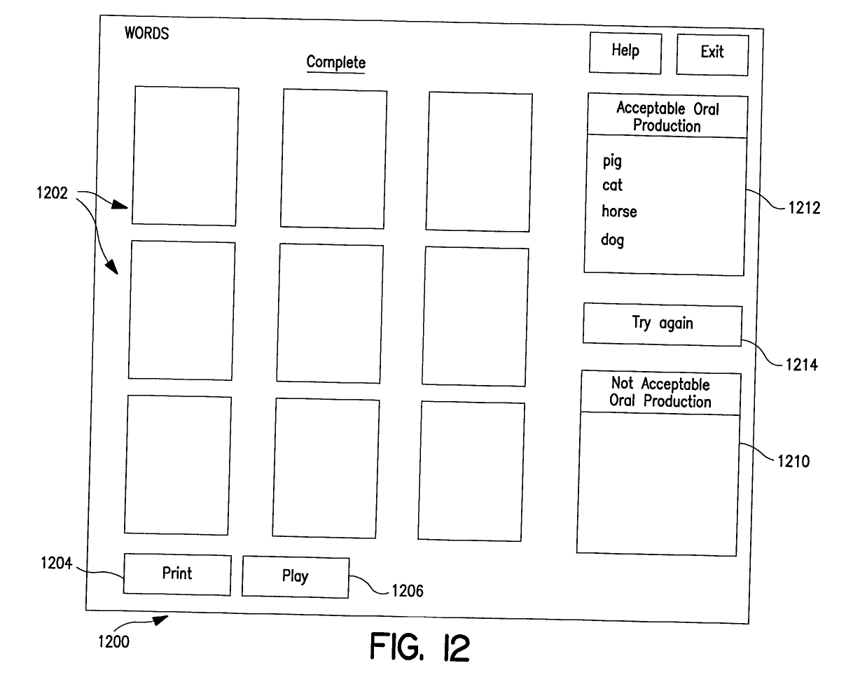

FIG. 12 is a representation of a story panel completion screen display 1200 of the FIG. 1 computer. FIG. 12 indicates that the user has successfully navigated through multiple story display screens. That is, with each input accepted as a permitted word and acceptably close to the desired oral production (such as the accepted spoken input to the prompt of FIG. 8), the user will be shown a new display panel and will be provided with a new prompt (such as the FIG. 9 display screen). Each accepted spoken input will be temporarily stored to comprise a next panel in the story being created by the user for the computer assisted exercise. FIG. 12 shows an array of panels 1202 corresponding to the accepted spoken inputs and corresponding story elements.

The Print display button 1204 initiates a print process that will produce paper copy of the story panels 1202. The printing provides an additional opportunity to provide positive feedback for the user to maintain motivation for the language learning process. A Play display button 1206 initiates computer readback of the user's story, providing yet another opportunity for positive feedback to the user. If desired, the user will not be shown the FIG. 12 display until all words whose pronunciation was not acceptably close are successfully retried by the user and accepted. This scheme is illustrated in FIG. 12, in that no words are remaining in the Not Acceptable box 1210, but are all in the Acceptable Oral Production box 1212. Alternatively, the user may be shown the FIG. 12 display upon completing all the story panels, but may be required to successfully pronounce all words before the Print button will be operative. The Try Again display button 1214 may therefore be used to initiate attempts to move words from the Not Acceptable box 1210 into the Acceptable box 1212 and permit printing.

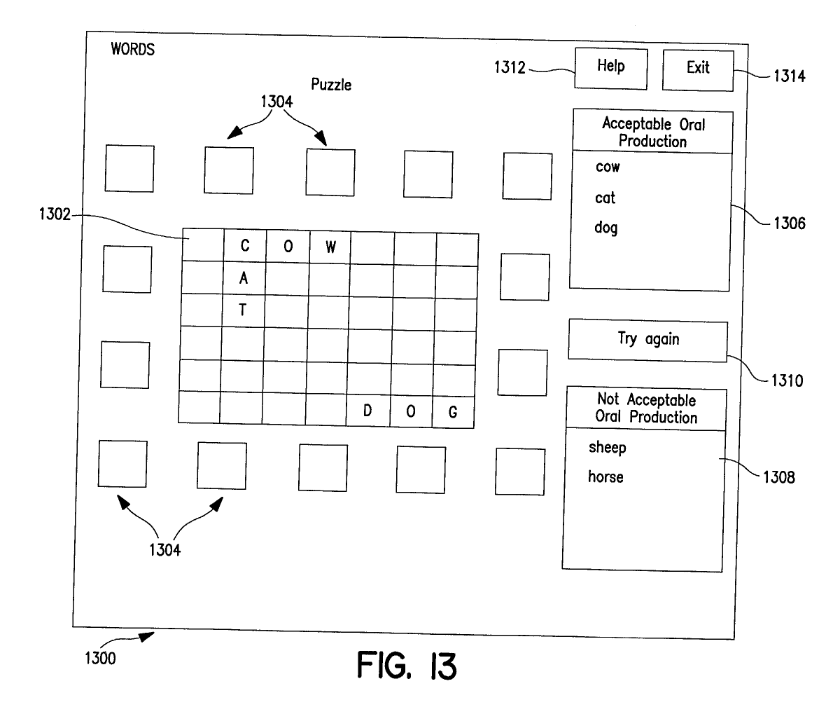

FIG. 13 is a Puzzle display page screen 1300 of the FIG. 1 computer that is presented to the user upon the user selecting the Puzzle display button 506 from the main screen display 500 (FIG. 5). The Puzzle screen provides yet another exercise in the language instruction book 110 that is related to network display pages that may be accessed from the computer as the user follows along in the book. Many different puzzle exercises may be provided to the user, and will occur to those skilled in the art. The puzzle operation described here is but one example of the puzzle exercise that is possible with the book and supplemental computer processing.

The display screen example 1300 of FIG. 13 shows a puzzle diagram 1302 with word boxes 1304 arrayed around the diagram. To complete the puzzle, the user must select a word box and then provide a spoken input by pronounce the word out loud in a recording operation of the computer. If the user's spoken input is accepted, the computer user interface operation places the word in the Acceptable Oral Production box 1306 and places the word in its location within the puzzle diagram 1302. Any words whose spoken pronunciation by the user was not accepted will be placed by the computer into the Not Acceptable box 1308. The Try Again display button 1310 permits the user to retry unaccepted words, subject to the limitations discussed above. The Help 1312 and Exit 1314 display buttons have the same functions as described above for the other display screens.

### Non-Contextual Instruction Aids

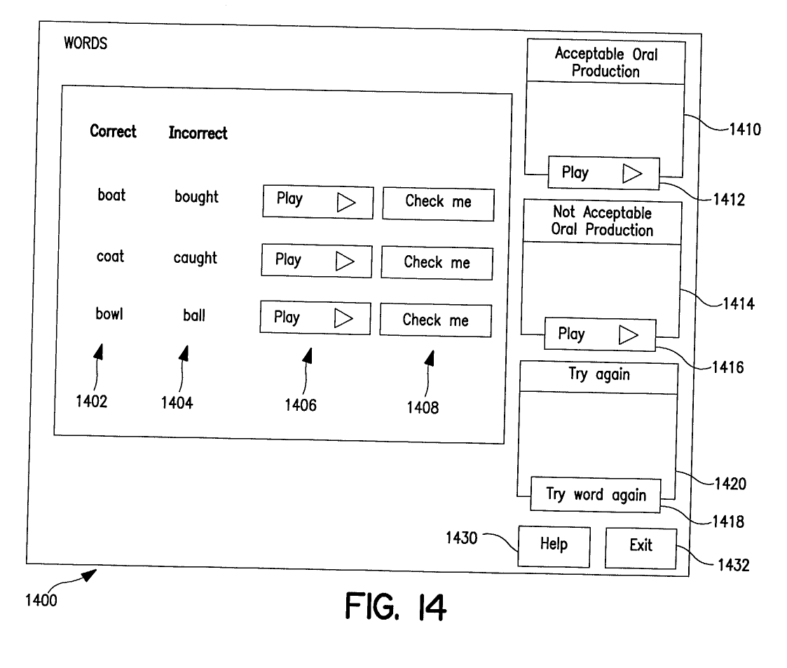

FIG. 14 is a non-contextual language instruction display page screen 1400 of the FIG. 1 computer. This non-contextual page may be shown to the user by the language processor computer 104 whenever additional practice is appropriate, whether the user is involved with the read-along application of FIG. 2 through FIG. 4 or the Words exercise book of FIG. 5 through FIG. 13. The non-contextual language instruction display 1400 provides an opportunity for additional practice by the user on words, phrases, or sounds that are indicated to be of particular trouble to the user.

The particular trouble to the user is indicated, for example, by the user pronouncing a word in a manner such that the word is correct, but the pronunciation not accepted, on more than two occasions. For example, in the display screens described above, the user may select “Try Again” more than once (indicating the spoken input was not accepted two times), but upon the second Try Again, the user will be shown the non-contextual language instruction screen 1400. In contrast to the practice screens described above for each particular primary text (either FIG. 2 through FIG. 4 or FIG. 5 through FIG. 13), the language instruction presented in the FIG. 14 non-contextual display is not dependent on the referring screen or on the context of the exercises from which the user was referred.

It has been determined that an important aspect of non-contextual language instruction is repeated exposure to correct sounds, or phoneme combinations, as well as examples of correct and incorrect speech patterns for a desired sound to be pronounced in the target language. Therefore, the FIG. 14 display 1400 permits the user to see various words having similar sounding phonemes, and then play back the words to compare and contrast the sounds. Thus, FIG. 14 shows columns of correct words 1402 and also incorrect words 1404. Each of the correct and incorrect words is associated with a Play display button 1406 so the user may select or click on the Play button and hear the associated words pronounced by a native speaker in the target language. As each word is pronounced, the word is highlighted, to direct the user's attention to the word. Each Play display button is associated with a “Check Me” display button. When the user selects the Check Me button, the system selects one of the associated words or the other and causes the word pronunciation to be played again, thereby prompting the user to select the word that was heard being spoken. This checks the user's comprehension of what each word sounds like, properly spoken by a native speaker.

When the user is ready to attempt once again pronouncing the word whose spoken input was not acceptably close to the desired sound, the user may repeat the word. The repeated pronunciation by the user involves the display area to the right of FIG. 14. If the user's spoken input is judged acceptably close, the word will be placed in the Acceptable Oral Production box 1410 of the display page 1400. The user may repeatedly play back the user's spoken input, if desired, by using a Play button 1412. If the spoken input is not judged acceptably close, then the word is placed in the Not Acceptable Oral Production box 1414, and the user may hear the user's not acceptable spoken input by selecting a Play display button 1416. Whenever the user desires another attempt at producing an acceptable spoken input, the user may select the Try Word Again display button 1418 to initiate a recording operation in which the user will speak into the microphone. Upon speaking into the microphone, the audio signal produced by the microphone and corresponding to the user's spoken input will be received by the language processor computer, and the computer will analyze the user's spoken input for acceptability. If desired, the Try Word Again display button may be accompanied by a graphical image box 1420 that contains an illustration of the word sound being practiced, as well as written representations of the word, both in the target language and translated into the user's native language. A Help display button 1430 and an Exit display button 1432 permit the user to request assistance with the non-contextual help and to return to the referring display screen.

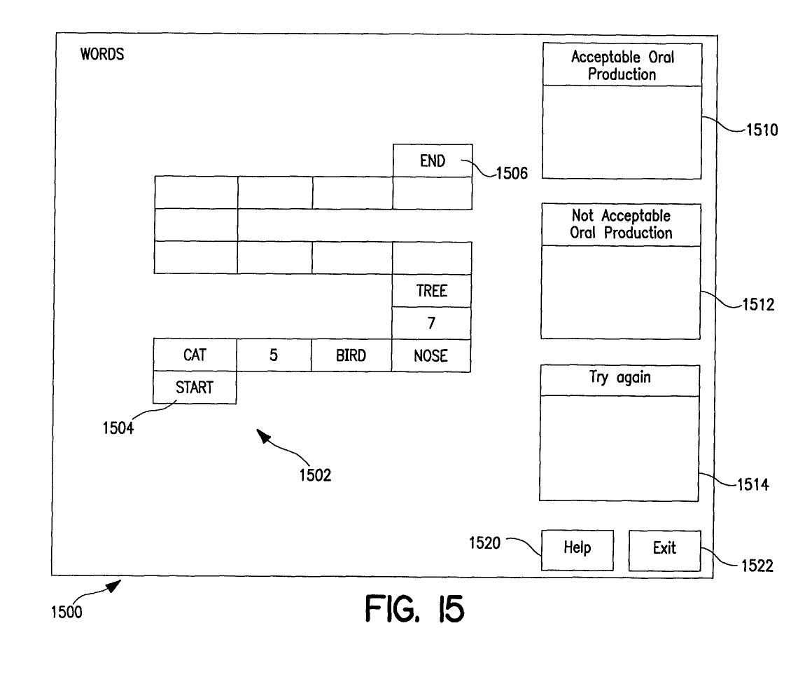

FIG. 15 is a second non-contextual language instruction display page 1500 that involves user interaction through the FIG. 1 computer. FIG. 15 shows an example of another way for providing non-contextual additional practice for a user. The FIG. 15 display 1500 includes a puzzle-like exercise that includes a diagram with word and number sounds that the user must traverse from a Start box 1504 to an End box 1506 before being automatically returned to the referring display. Alternatively, the user may select each box of the diagram 1502 at random for attempts at accepted pronunciation, to eventually complete the diagram. Not every diagram box 1502 is shown with words or numbers for pronunciation, for simplicity of illustration, but it is to be understood that the actual computer display page will contain such information in each box.

The user completes the diagram by pronouncing each word, number, or phrase contained in the boxes of the diagram 1502 so that each spoken input is accepted by the language processor computer. As the user produces a spoken input that is correct and accepted, the corresponding word or number or phrase is placed in the Acceptable Oral Production box 1510. The corresponding box in the diagram 1502 is preferably highlighted or changed in some fashion to indicate that the user has successfully completed the task for that box. If the user's spoken input is not correct but is accepted, the word or number or phrase is placed in the Not Acceptable Oral Production box 1512. A Try Again display button 1514 is provided for repeated attempts at pronunciation.

A Help display button 1520 initiates assistance for the user, and an Exit display button 1522 returns the user to the referring display page.

### Processor block diagram

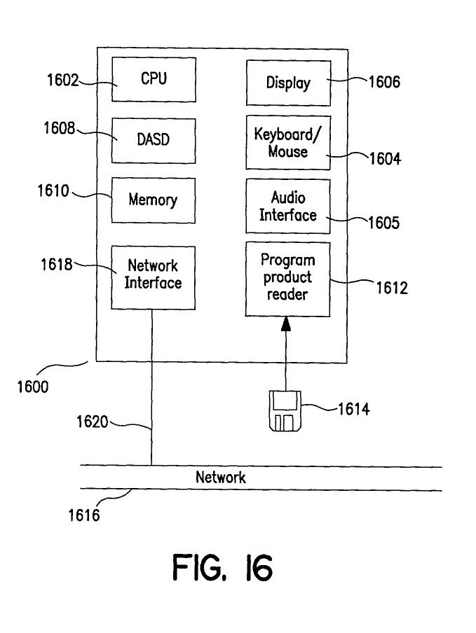

FIG. 16 is a block diagram representation of a computer used in the system illustrated in FIG. 1. The computing device that implements the processing of the user's language processor computer 104 and the computing device that implements the processing of the support server 122 of FIG. 1, or any other computer of the system 100, may comprise a variety of processing devices, such as a handheld device, a Personal Digital Assistant (PDA), and any conventional computer suitable for implementing the functionality described herein. Other constructions are possible as well. For example, other constructions for the language processor computer may be utilized, so long as the language processor computer is capable of receiving spoken input from the user and producing a corresponding audio signal that may be further processed and sent to the support server 122 for analysis.

FIG. 16 is a block diagram of an exemplary computer device 1600 such as might comprise the computing devices shown in FIG. 1. Each computer operates under control of a central processor unit (CPU) 1602, such as an application specific integrated circuit (ASIC) from a number of vendors, or a “Pentium”-class microprocessor and associated integrated circuit chips, available from Intel Corporation of Santa Clara, Calif., USA. Commands and data can be input from a user control panel, remote control device, or a keyboard and mouse combination 1604. The user's language processor computer 104 (FIG. 1) is a voice-enabled device that can receive spoken input from the user, and therefore the user's PC will include a microphone and sound card interface 1605, in addition to the keyboard and mouse. Computer inputs and output can be viewed at a display 1606. The display is typically a video monitor or flat panel display device.

The computer device 1600 may comprise a personal computer or, in the case of a client machine, the computer device may comprise a Web appliance or other suitable network communications, voice-enabled device. In the case of a personal computer, the device 1600 preferably includes a direct access storage device (DASD) 1608, such as a fixed hard disk drive (HDD). The memory 1610 typically comprises volatile semiconductor random access memory (RAM). If the computer device 1600 is a personal computer, it preferably includes a program product reader 1612 that accepts a program product storage device 1614, from which the program product reader can read data (and to which it can optionally write data). The program product reader can comprise, for example, a disk drive, and the program product storage device can comprise removable storage media such as a floppy disk, an optical CD-ROM disc, a CD-R disc, a CD-RW disc, a DVD disk, or the like. Semiconductor memory devices for data storage and corresponding readers may also be used. The computer device 1600 can communicate with the other connected computers over a network 1616 (such as the Internet) through a network interface 1618 that enables communication over a connection 1620 between the network and the computer device 1600.

The CPU 1602 operates under control of programming steps that are temporarily stored in the memory 1610 of the computer 1600. When the programming steps are executed, the pertinent system component performs its functions. Thus, the programming steps implement the functionality of the system illustrated in FIG. 1. The programming steps can be received from the DASD 1608, through the program product 1614, or through the network connection 1620, or can be incorporated into an ASIC as part of the production process for the computer device. If the computer device includes a storage drive 1612, then it can receive a program product, read programming steps recorded thereon, and transfer the programming steps into the memory 1610 for execution by the CPU 1602. As noted above, the program product storage device can comprise any one of multiple removable media having recorded computer-readable instructions, including magnetic floppy disks, CD-ROM, and DVD storage discs. Other suitable program product storage devices can include magnetic tape and semiconductor memory chips. In this way, the processing steps necessary for operation in accordance with the invention can be embodied on a program product.

Alternatively, the program steps can be received into the operating memory 1610 over the network 1616. In the network method, the computer receives data including program steps into the memory 1610 through the network interface 1618 after network communication has been established over the network connection 1620 by well-known methods that will be understood by those skilled in the art without further explanation. The program steps are then executed by the CPU 1602 to implement the processing of the system.

### Processing Flow

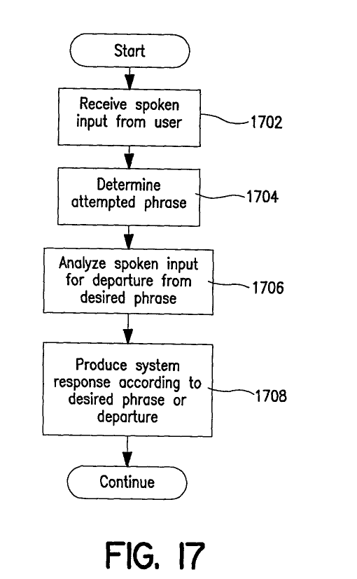

FIG. 17 is a flow diagram that illustrates operations of the system illustrated in FIG. 1 to process the user's spoken input. In the first processing operation, represented by the flow diagram box numbered 1702, the user's computer receives spoken input from the user through the microphone. The computer transduces the user's speech into an audio signal representation suitable for computer analysis. In the next operation, the system carries out that analysis and determines the phrase that was spoken by the user. That is, the system determines the phrase the user was attempting to speak. This operation is indicated by the flow diagram box numbered 1704. The analysis of the user's spoken input may be carried out by the user's language processor computer, by the support server, or by a combination of operations distributed among the two.

The system also analyzes the user's spoken input to determine how far it is from the desired (target) phrase. The “distance” from the desired phrase may be calculated into a numerical score using known language processing techniques so the departure or distance is specified in terms of a likelihood that the spoken input corresponds to the desired oral production. Alternatively, the departure from the desired phrase may be specified in terms of one or more specific errors in the spoken input as compared to the desired oral production. The operation to provide the product of the analysis in terms of departure from desired is indicated by the flow diagram box numbered 1706. This operation may be carried out simultaneously with the phrase determination operation. For example, the system may determine the user's spoken input phrase by comparing the user's spoken input against a data base of spoken words. The comparison may be performed by determining how far the user's spoken input is from each data base word, so that the data base word that is the closest to the user's spoken input is judged the word most likely spoken by the user. Thus, at once, both the attempted word and the departure of the user's spoken input from the desired word are determined.

In the next operation, specified by the flow diagram box numbered 1708, the system produces a system response to the determination 1706, in accordance with the desired (target) phrase or the departure of the user's spoken input from the desired oral production. The system response may be any of the responses described above in connection with a user spoken input, such as moving a word into an “Acceptable Oral Production” box or a “Not Acceptable Oral Production” box, taking the user to a word practice display, highlighting an accepted display word, providing the user with a non-contextual word practice display, or the like.

### Command Instruction

The system 100 can be used to teach the meaning of phrases that can be associated with a particular action or command. For example, phrases may have particular significance as commands, such as the positional phrases “left”, “right”, “up”, and “down”. Other phrases whose meaning may be taught in this way include phrases that may be interpreted as a command to change the display. Such phrases may comprise, for example, adjectives such as color. In the case of color adjectives, the use may speak a color (such as “red” or “blue”) and the system will change the color of an object accordingly. In this way, the user will associate the phrase with the display change, and will be taught the meaning of the phrase. Other phrases that may be interpreted as commands to teach their meaning in this way include, for example, numbers, movement, and sounds. Such instructional features will be referred to as command instruction features, and may be provided in addition to, or in place of, any of the other instructional features described above.

In the preferred embodiment of a system with the command instruction feature, a user views an interface display screen that includes a representation of a virtual environment containing one or more objects that are subject to command operations. For example, the virtual environment may contain a ball that is positioned relative to a table. The phrases may change the position of the objects, their color, number, and so forth.

The user speaks an input command comprising a permitted command operation relating to the objects in the virtual environment, such as up or down. The system receives the user spoken input, recognizes the spoken input command as being one of the alternative accepted command operation input phrases, thereby defining a predetermined meaning for the spoken input command. The phrase may be placed in an “Acceptable Oral Production” box. The system then changes the display to produce a display screen in which the user spoken command has been implemented on the objects in the virtual environment. For example, the user may speak “Left” to move the ball to the left of the table, or may speak “Up” to move the ball on top of the table. Words that the user does not pronounce acceptably close to the desired pronunciation will, as described above, be placed in a “Not Acceptable Oral Production” display box. In this way, the user practices pronunciation of the command terms and observes the meaning of the term by observing the resulting action.

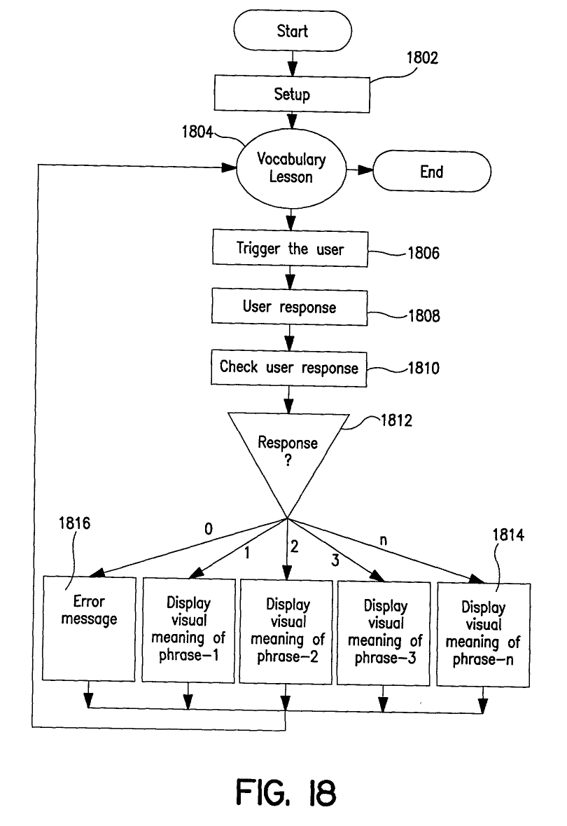

FIG. 18 shows a flow diagram of the system operation to provide the command feature. The first operation is a setup operation 1802, such as might be performed upon the initialization of any communication session with the language instruction system 100 (FIG. 1). The setup may include, for example, user authorization operations. Next, indicated at box 1804, the system retrieves a vocabulary lesson or other language instruction exercise from a system database. If no lessons are available, indicating the completion of a study unit, then the system operation ends. The system otherwise continues operation with a display screen presentation that triggers the user to provide voice input, as indicated by the flow diagram box numbered 1806. The presentation will provide the user with a display of the virtual environment in which the prepositional commands will be received and implemented.

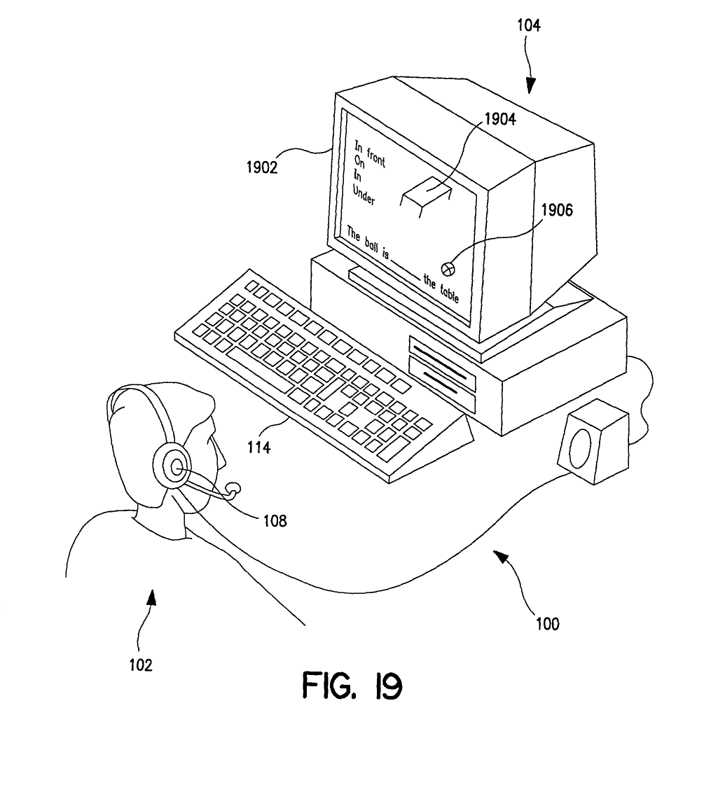

FIG. 19 shows an example of the command presentation display screen 1902 of the computer 104, which is being viewed by the user 102. The display screen shows a virtual environment having a table 1904 and a ball 1906. The display screen shows the user a phrase into which the user may insert alternative commands. In FIG. 19, the illustrated phrase is “The ball is [ ] the table.” The alternative prepositional commands are shown as “in front”, “on”, “in”, and “under”. The display screen serves as a trigger to the user, prompting the user to provide an input comprising a selection of a prepositional command, followed by a spoken input comprising the user speaking the selected word. Thus, the FIG. 19 screen presentation corresponds to the trigger operation 1806 of FIG. 18.

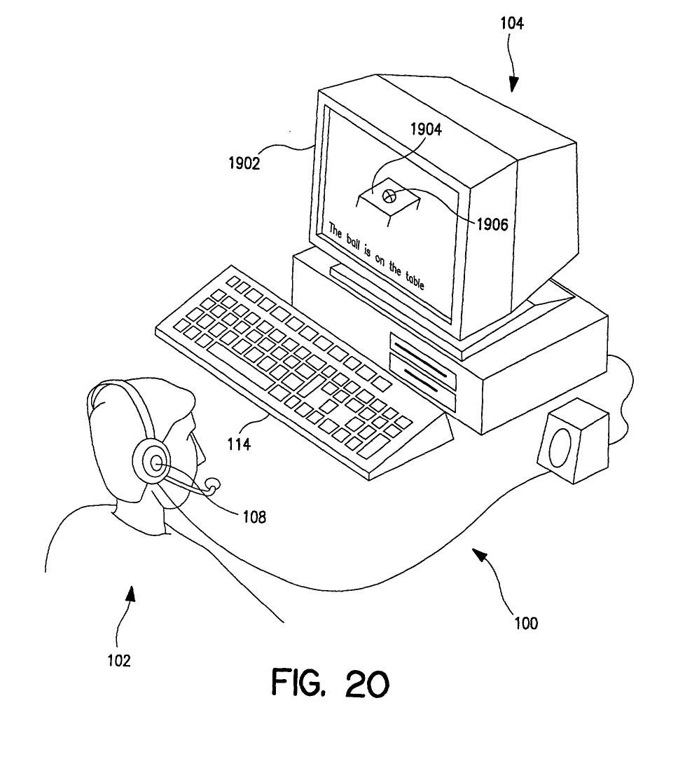

When the user selects a prepositional command word, the system begins a recording operation in which the user speaks into the system microphone and an audio signal corresponding to the user's spoken input is produced. This operation is represented by the flow diagram box numbered 1808. Next, at box 1810, the system analyzes the user's spoken input. At the decision box 1812, the system analyzes the spoken input to determine the phrase that was spoken by the user and to determine if the phrase corresponds to one of the permitted phrases, indicated by the decision arrows 1, 2, 3, . . . , n. If the system determines that the user's spoken input was most likely one of the permitted words, then the system implements the spoken input according to the meaning of the permitted phrase, as indicated by the flow diagram box numbered 1814. FIG. 20 shows the next screen display, in which the command corresponding to the user's spoken input is implemented. Thus, in the example, the user's input to FIG. 19 was “on”, and therefore in FIG. 20 the ball is shown on top of the table. If the system does not recognize the user's spoken input as one of the permitted prepositional commands, the system will return an error message or otherwise provide additional practice, as indicated by the box 1816. Processing will then return to the vocabulary lesson processing of box 1804. In this way, the instructional system 100 can provide interactive instruction in the meaning of words of a target language, and can also provide an opportunity to practice speaking the words.

Other types of commands and word meanings will occur to those skilled in the art, and are not limited to simple movement commands. Rather, the vocabulary words that may be taught through the command feature described above can comprise a wide variety of complexity, including a variety of educational levels. For example, the terms being practiced can comprise scientific or medical terms, and the actions in the virtual environment can produce a wide variety of results.

The present invention has been described above in terms of a presently preferred embodiment so that an understanding of the present invention can be conveyed. There are, however, many configurations for language instruction systems not specifically described herein but with which the present invention is applicable. The present invention should therefore not be seen as limited to the particular embodiments described herein, but rather, it should be understood that the present invention has wide applicability with respect to language instruction generally. All modifications, variations, or equivalent arrangements and implementations that are within the scope of the attached claims should therefore be considered within the scope of the invention.

I claim:

1. A method of providing language instruction through oral production of phrases by a user, the method comprising:
receiving a spoken input from a user into a language instruction system;
recognizing the spoken input as being one of alternative permitted input phrases in a database of the language instruction system, thereby determining a predetermined meaning for the spoken input; and
performing a system analysis of the spoken input and identifying a departure of the spoken input from a desired oral production of the permitted input phrase.

2. A method as defined in claim 1, further including implementing a system response to the spoken input in accordance with the predetermined meaning.

3. A method as defined in claim 2, wherein implementing comprises producing a visualization of the system response on a display device.

4. A method as defined in claim 3, wherein implementing a system response comprises:
displaying a user interface screen on a display device, wherein the user interface screen includes a representation of a virtual environment containing one or more objects subject to command operations;
receiving a user spoken command comprising a permitted command operation relating to the objects in the virtual environment; and
producing a supplemental user interface screen in which the user spoken command has been implemented on the objects in the virtual environment.

5. A method as defined in claim 4, wherein the user spoken command comprises a phrase that the system interprets as a command to change the displayed user interface screen.

6. A method as defined in claim 4, wherein the permitted command operation comprises a positional command that indicates a physical movement of one object in the virtual environment relative to another.

7. A method as defined in claim 1, farther including presenting the user with a learning presentation teaching a desired input phrase prior to receiving the spoken input.

8. A method as defined in claim 7, wherein the learning presentation relates to the desired input phrase meaning.

9. A method as defined in claim 7, wherein the learning presentation includes written material.

10. A method as defined in claim 7, wherein the desired input phrase comprises content from a story and is included in a multimedia presentation of the story.

11. A method as defined in claim 10, wherein the multimedia presentation includes printed material.

12. A method as defined in claim 1, wherein the identified departure of the spoken input is specified in terms of a likelihood that the spoken input corresponds to the desired oral production.

13. A method as defined in claim 1, wherein the identified departure of the spoken input is specified in terms of one or more specific errors in the spoken input as compared to the desired oral production.

14. A method as defined in claim 13, wherein the specific errors are dependent on the user's native language.

15. A method as defined in claim 1, wherein the user spoken input may include a plurality of alternative permitted input phrases, and recognizing and analyzing are performed for each of the alternative permitted input phrases.

16. A method as defined in claim 2, further including:
initiating the system response only if the analysis indicates that the spoken input is acceptably close to the desired oral production.

17. A method as defined in claim 2, further including:
initiating the system response if the spoken input is acceptably close to the desired oral production or if the spoken input is not acceptably close to the desired oral production for at least a predetermined number of times, thereby comprising a spoken input that is one of the permitted input phrases and is not acceptably close to the desired oral production.

18. A method as defined in claim 17, wherein the predetermined number of times is one.

19. A method as defined in claim 2, further including:
maintaining a record of spoken inputs that are permitted input phrases and are not acceptably close to the desired oral production; and
permitting the user to reproduce one or more of the permitted input phrases corresponding to a spoken input that is permitted but is not acceptably close to the desired oral production, thereby comprising a spoken input retry.

20. A method as defined in claim 19, further including:
receiving the spoken input retry;
analyzing the spoken input retry for a departure of the spoken input retry from the corresponding desired oral production; and
deleting from the record the spoken input that corresponds to a permitted input phrase but is not acceptably close to the desired oral production, if the analysis indicates that the spoken input retry is acceptably close to the desired oral production.

21. A method as defined in claim 2, wherein the initiated response to a spoken input that corresponds to a permitted input phrase that is acceptably close to the desired oral production is different from the initiated response to a spoken input that corresponds to a permitted input phrase that is not acceptably close to the desired oral production.

22. A method as defined in claim 2, wherein the system recognizes only one permitted input phrase from the system database.

23. A language instruction system comprising:
a presentation system that produces output that can be perceived by a user;
a microphone that transduces spoken input from the user and produces an audio output representation corresponding to the spoken input;
a processor that receives an audio output representation of the spoken input from the user and recognizes the spoken input as being one of alternative permitted input phrases in a database of the language instruction system, thereby determining a predetermined meaning for the spoken input, and performs a system analysis of the spoken input and identifies a departure of the spoken input from a desired oral production of the permitted input phrase.

24. A computer-assisted language instruction system comprising:
presentation means for producing a system output that can be perceived by a user;
a microphone that transduces spoken input from the user and produces audio data corresponding to the user's spoken input;
input processor means for receiving the audio data and determining if the spoken input corresponds to a permitted input phrase in a database of the language instruction system, thereby determining a predetermined meaning for the spoken input; and
analysis means for analyzing the spoken input and identifying a departure of the spoken input from a desired oral production of the permitted input phrase.

25. A system as defined in claim 24, wherein the system output produced by the presentation means comprises a system response to the spoken input in accordance with the predetermined meaning for the user's spoken input.

26. A system as defined in claim 24, wherein the analysis means identifies the departure of the user's spoken input from the desired oral production in terms of a likelihood that the spoken input corresponds to the desired oral production.
